(19) United States
(12) Patent Application Publication
(10) Pub. No.: US 2013/0033679 A1
(43) Pub. Date: Feb. 7, 2013

(54) PROJECTION SYSTEM, PROJECTOR, AND PROJECTION METHOD

(71) Applicant: Shinya MUKASA, Shizuoka (JP)

(72) Inventor: Shinya MUKASA, Shizuoka (JP)

(73) Assignee: RICOH COMPANY, LTD., Tokyo (JP)

(21) Appl. No.: 13/554,097

(22) Filed: Jul. 20, 2012

(30) Foreign Application Priority Data
Aug. 1, 2011 (JP) 2011-168664

(51) Int. Cl. G03B 21/26

(52) U.S. Cl. 353/30; 353/121

(57) ABSTRACT

A disclosed projection system includes a computer; and a projector configured to project projection image data received from the computer, wherein the computer includes a receiving part configured to receive the projection image data, which are projected, from the projector, a drawing part configured to draw drawing data, which are additionally drawn on the projection image data, and a transmitting part configured to transmit the drawing data to the projector, wherein the projector includes a transmitting part configured to transmit the projection image data to the computer, a receiving part configured to receive the drawing data from the computer, an image combining part configured to generate combined image data by combining the projection image data, which are projected, with the drawing data, and a projecting part configured to project the combined image data as projection image data.

### BACKGROUND OF THE INVENTION

1. Field of the Invention

The present invention generally relates to a projection system, a projector, and a projection method.

2. Description of the Related Art

In meetings, a personal computer (PC) and a projector connected to the PC via a network may be used. In this case, material data (e.g., a presentation material) on the screen of the PC are transmitted to the projector as projection image data. The meeting may proceed while projection image data are projected on a whiteboard, a screen, or the like. During the meeting, explanation may be given to the projection image which shows the material data, or an opinion or an idea is provided to the material data. For this, a meeting participant may handwrite on the whiteboard to superpose a drawing on a projection image projected on the whiteboard. Meanwhile, when a PC operator is a moderator and writes an explanation, an opinion, and an idea on the material data on the screen of the PC, the written content on the material data is also projected on the whiteboard in real time so as to be reflected in the whiteboard.

The explanation, the opinion and the idea written in the meeting are preferably recorded as a deliverable. Therefore, the material data on which the written content is provided are required to be stored as minutes of meeting. In a case where the PC operator writes on the material data on the screen of the PC, it is possible to easily store the material data on which the written content is provided in the PC. On the other hand, when the meeting participant writes on the projection image projected on the whiteboard using a marking pen or the like, the material data in the PC are not reflected by the written content. Therefore, it may be required to reflect the written content on the material data in the PC.

As a technique related to the reflection of the written content on the material data in the PC, Patent Document 1 discloses a structure in which a screen displaying a part of an electronic document is simultaneously displayed on two different display devices. Further, a written content superposed on the screen displaying the part of the electronic document is captured and changed into data. Further, the written content is attached to the data of the part of the electronic document and is shared between the different display devices via a network. Said differently, an image of the whiteboard is captured by a camera, and the captured image and the projected image are superposed and stored. Thus, characters and figures written on the whiteboard are stored as the deliverable.

However, when the PC operator writes on the material data displayed on the PC screen as described above, another meeting participant cannot write on the material data displayed on the PC screen. It frequently occur in meetings that meeting participants freely write on material data projected on a screen while the meeting participants presenting an explanation, an opinion or an idea. If only the PC operator can write on material data displayed on the PC screen, it is very inconvenient for proceeding of the meeting.

On the other hand, if the meeting participant writes on the projection image projected on the whiteboard using a marling pen or the like, the material data on which the written content is provided can be stored by applying an invention described in Patent Document 1, and the meeting participant can freely write on the projected material data.

However, in this case, a camera is required to be prepared. Thus, additional facilities and cost become necessary. Further, because quality of an image captured by a camera is sometimes insufficient, material data on which the written content is provided may have insufficient image quality. All meeting participants cannot always write on the projected material data. For example, the meeting participant who does not exist near the whiteboard, for example, a participant joining the meeting from a distance by a telephone or the like cannot write on the screen or the whiteboard.

Patent Document 1: Japanese Laid-Open Patent Application No. 2005-051446

### SUMMARY OF THE INVENTION

Accordingly, embodiments of the present invention provide a novel and useful projection system, a projector, and a projection method, with which all meeting participants can write drawing information (additional information) such as characters and figures on an image projected by the projector, and storage capability is improved.

One aspect of the embodiments of the present invention may be to provide a projection system includes a computer; and a projector configured to project projection image data received from the computer, wherein the computer includes a receiving part configured to receive the projection image data, which are projected, from the projector, a drawing part configured to draw drawing data, which are additionally drawn on the projection image data, and a transmitting part configured to transmit the drawing data to the projector, wherein the projector includes a transmitting part configured to transmit the projection image data to the computer, a receiving part configured to receive the drawing data from the computer, an image combining part configured to generate combined image data by combining the projection image data, which are projected, with the drawing data, and a projecting part configured to project the combined image data as projection image data.

The present invention is effectively applicable to a method, a device, a system, a computer program, a recording medium and so on.

Additional objects and advantages of the embodiments will be set forth in part in the description which follows, and in part will be clear from the description, or may be learned by practice of the invention. Objects and advantages of the invention will be realized and attained by means of the elements and combinations particularly pointed out in the appended claims.

It is to be understood that both the foregoing general description and the following detailed description are exemplary and explanatory only and are not restrictive of the invention as claimed.

### BRIEF DESCRIPTION OF THE DRAWINGS

FIG. 1 illustrates a network structure of a projection system of the embodiment;

FIG. 2 illustrates a hardware structure of a projector of an embodiment;

FIG. 3 illustrates a hardware structure of a personal computer of the embodiment;

FIG. 4 illustrates an exemplary functional block of the projector and the personal computer of the embodiment;

FIG. 5 is state transition diagrams illustrating the display of the personal computer and the projection image;

FIG. 6 is a flowchart illustrating a process of supplying image data from the PC 20a, first projection of the image data by the projector 10, and reflection on the personal computer;

FIG. 7 is a flowchart illustrating writing on image data displayed on the screen of the personal computer, projection of the written data by the projector, and reflection of the written data on the personal computer;

FIG. 8 illustrates an example of an image combination;

FIG. 9 is state transition diagrams illustrating the display of the personal computer and the projection image;

FIG. 10 is a flowchart illustrating deletion of image data supplied from the personal computer, projection of the deleted image data by the projector, and reflection of the deleted data on the personal computer;

FIG. 11 illustrates a network structure of another projection system of an modified example of the embodiment; and

FIG. 12 illustrates a functional relationship of the other projection system of the modified example of the embodiment.

### DETAILED DESCRIPTION OF THE PREFERRED EMBODIMENTS

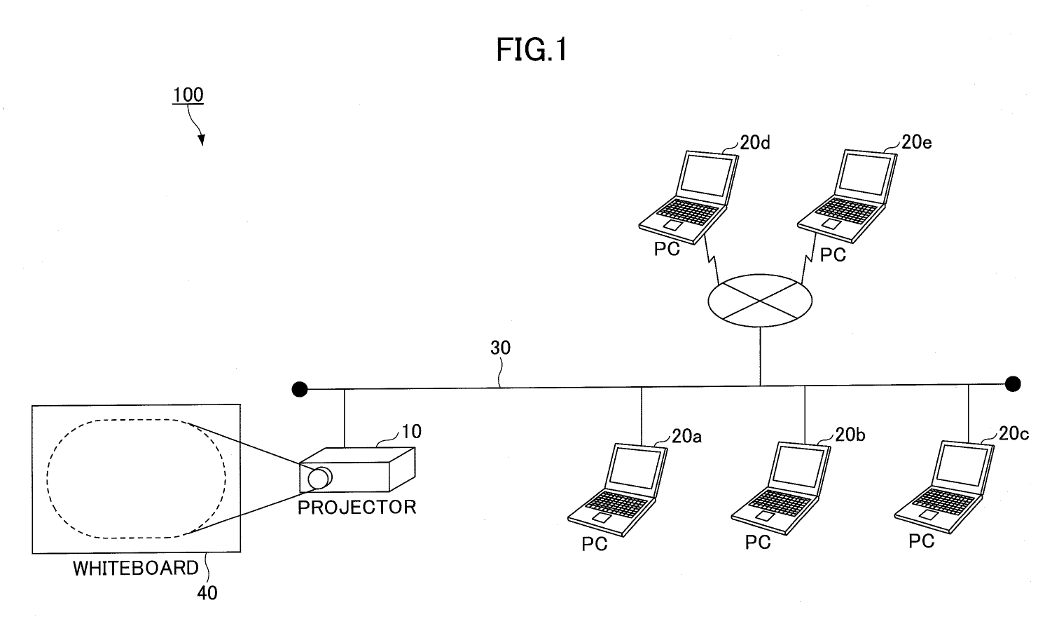

A description is given below, with reference to the FIG. 1 through FIG. 12 of embodiments of the present invention. Where the same reference symbols are attached to the same parts, repeated description of the parts is omitted.

Reference symbols typically designate as follows:
100: projection system;
10: projector;
11: projecting part;
12: control part;
121: CPU;
122: RAM;
123: storage
124: ROM;
125: projection control part;
126: operation part;
127: communication interface;
20: PC;
21: CPU;
22: ROM;
23: RAM;
24: HDD;
25: recording medium reading device;
26: input device;
27: display device;
28: communication device;
30: network;
40: whiteboard;
101: receiving part;
102: memory part;
103: image combining part;
104: projecting part;
105: transmitting part;
201: receiving part;
202: memory part;
203: displaying part;
204: drawing part; and
205: transmitting part.

### [System Structure]

### (Network Structure)

FIG. 1 illustrates a network structure of a projection system 100 of the embodiment. The projection system 100 of the embodiment is formed such that the projector 10 and the personal computer (PC) 20 including the PCs 20a to 20e are connected via the network 30.

The projector 10 receives projection image data from the PC 20 and projects a projection image on, for example, a whiteboard. The projector 10 is connected to the PC 20 via the network 30. Data such as presentation material are transmitted from the PC 20 to the projector 10 as the projection image data. The projector 10 projects the received projection image data on the whiteboard 40 or the like as the projection image.

The PC 20 is a PC terminal for a meeting participant. The PC 20 is connected with the projector 10 via the network 30. Within the embodiment, the meeting participant participates in the meeting after connecting his or her PC terminal to the network. Further, as illustrated in FIG. 1. the number of the PC 20 may be plural like PCs 20a to 20e. The locations of the PCs 20a to PC 20e are not specifically limited. For example, the PCs 20a to 20c may exist in one meeting room together with the projector 10. The PCs 20d and 20e may be connected to the network 30 from a distant place outside the meeting room. Therefore, the PCs 20a to 20e can participate in the meeting.

The network 30 may be wired or wireless. The network 30 includes LAN and WAN. The network is not specifically limited as long as the PC 20 is connected with the projector 10 by the network so as to communicate with the projector.

In the meeting of the embodiment, a participant A who also is a moderator opens a presentation material file stored on an HDD of the PC 20a so as to be displayed on a screen of the PC 20a. Further, presentation material data displayed on the screen of the PC 20a are transmitted from the PC 20a to the projector 10. The projector 10 projects the received projection image data on the whiteboard 40 or the like as the projection image. The meeting participants in the meeting room watch the whiteboard 40 to thereby visually recognize the projection image data.

Further, the projector 10 of the embodiment projects the receive projection image data on the whiteboard 40 as the projection image. Meanwhile, the projector 10 can transmit or deliver the projection image data, which are being projected, to the PC 20 participating in the meeting. Therefore, the projection image data being the same as the projection image which is being projected on the whiteboard 40 is displayed on the screen of the PCs 20a to 20e. Therefore, the meeting participants in the meeting room where the projector 10 is installed can watch the projection image (e.g., the presentation material) on the whiteboard 40. Further, the projection image data (e.g., the presentation material data) can be watched on the screens of the PCs 20a to 20c. The meeting participant at a distant place can watch the projection image data (e.g., the presentation image data) on the screens of the PCs 20d and 20e. Detailed description of the PCs 20d and 20e is given later.

### (Hardware)

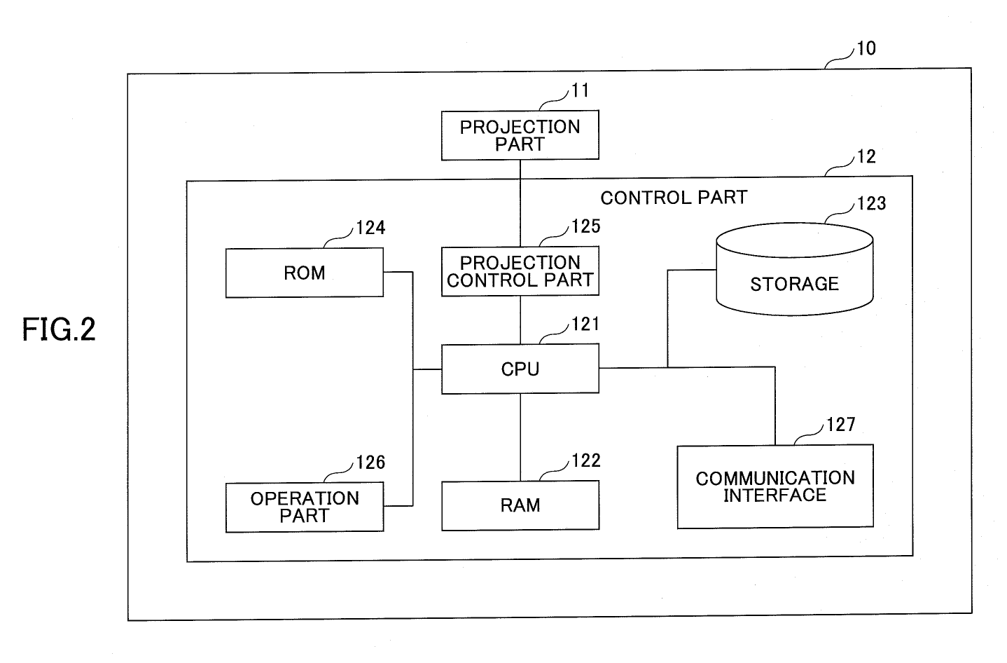

FIG. 2 illustrates the hardware structure of the projector 10 of the embodiment. The projector 10 includes a projecting part 11 for projecting projection image data so as to visualize the data and a control part 12 for performing overall control.

The projecting part 11 projects the projection image data and visualizes the projection image data as the projection image. Further, the control part 12 includes a CPU 121 for controlling the control part 12; a RAM 122 used by the CPU 121 as a working area when the CPU 121 executes the program and performs various controls; a storage 123 for storing the image data and the drawing data (additional information) or the like; a ROM 124 for storing a projector control program and parameters necessary for the control; a projection control part 125 for sending instructions of controlling a power source of the projecting part 11 and of causing the projection part 11 to project the projection image data; an operation part 126 as an input and output device for receiving instructions of operating the power source of the projecting part 11 and of selecting, projecting, operating pages or the like; and a communication interface 127 such as IrDA as a remote control interface which can perform operations similar to Ethernet (“Ethernet” is a registered trademark) being an interface with the network 30 and the operation part 126.

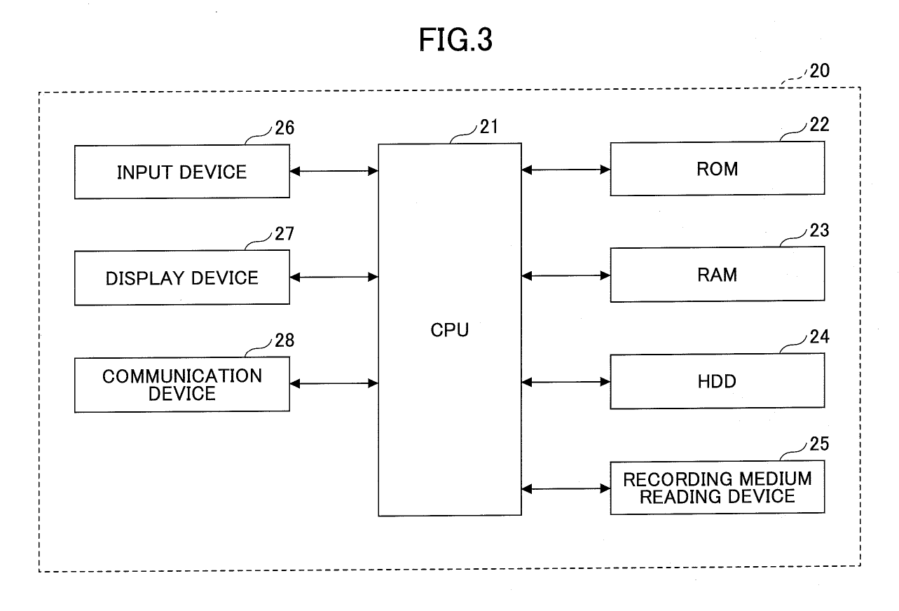

FIG. 3 illustrates a hardware structure of the PC 20 of the embodiment. The PC 20 includes the CPU 21, the ROM 22, the RAM 23, the HDD 24, the recording medium reading device 25, the input device 26, the display device 27, and the communication device 28.

The CPU 21 includes a microprocessor and a peripheral circuit of the microprocessor, and controls the image forming apparatus 1 in its entirety. The ROM 22 is a memory storing a predetermined program executed by the CPU 21. The RAM 23 is a memory used as a working area when the CPU 21 performs various controls by executing the predetermined program stored in the ROM 22. The HDD 24 is a non-volatile memory device for storing a general purpose OS and various information including various programs. The recording medium reading device 25 is a device for inputting information from an external memory medium such as a CD, a DVD and a USB memory or the like. The input device 26 is a device for a user to perform various inputs through the input device 26. The input device 26 includes a mouse, a key board, a touch panel switch arranged to overlap a display screen of the display device 27, and the like. The display device 27 is a device for displaying various data on the display screen. The display device 27 includes, for example, a liquid crystal display (LCD), a cathode ray tube (CRT) and so on. The communication device 28 is a device for communicating with other devices via the network 30. The communication device 28 supports communications in response to a network mode such as a wired network and a wireless network.

### (Function)

Next, the functional structure of the projection system 100 of the embodiment is described.

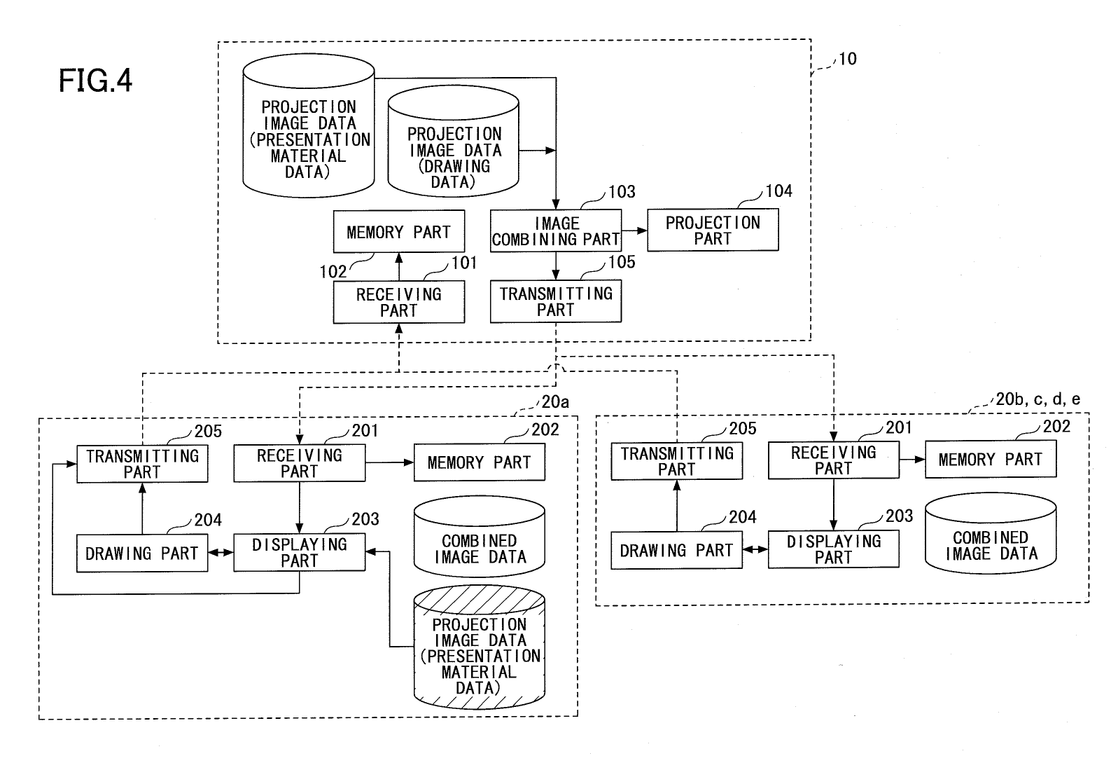

FIG. 4 illustrates an exemplary functional block of the devices of the embodiment. For convenience, the PC 20a and the PCs 20b to 20e are separated in FIG. 4. The PC 20a first (originally) serves projection image data such as presentation material data to the projector 10. The PC 20a may be used by ordinary meeting participants B to E. Said differently, the PC 20a first (originally) provides projection image data such as the presentation material data to the whiteboard 40. Therefore, the memory part 202 of the PC 20a has the projection image data first (originally) projected on the whiteboard 40. Foe example, the projection image data may be stored in a local HDD.

The projector 10 includes the receiving part 101, the memory part 102, the image combining part 103, the projecting part 104, and the transmitting part 105. The receiving part 101 receives the projection image data (e.g., the presentation material data) projected from the PC 20 and the drawing data additionally drawn on the projection image data (including the combined image data), which are being projected. The memory part 102 stores the projection image data received from the PC 20 projected by the projector 10 and the drawing data. The image combining part 103 generates combined image data by combining the projection image data to be first projected with the drawing data. The projecting part 104 projects the projection image data to be first projected and the combined image data. The transmitting part 105 projects the projection image data to be first projected and the combined image data on the whiteboard 40.

The PC 20 includes the receiving part 201, the memory part 202, the displaying part 203, the drawing part 204, and the transmitting part 205. The receiving part 201 receives the projection image data (e.g., the first projected projection image data and the combined image data) which is being projected from the projector 10. The memory part 202 stores the projection image data being the received combined image data. The displaying part 203 displays the projected projection image data or the projection image data (including the combined image data) which is being projected. The drawing part 204 draws drawing data added to the projection image data (including the combined image data), which are displayed on the displaying part 203 and projected on the whiteboard 40. The transmitting part 205 transmits the drawing data additionally drawn on the first projected projection image data or the projection image data which is being projected to the projector 10.

As described, the PC 20a and the PCs 20b to 20e are separated depending on whether the PCs provide the presentation material data in FIG. 4. However, depending on types of the meetings, all PCs 20 including the PCs 20b to 20e possibly needs to play a role of first providing the presentation material data in a manner similar to the PC 20a. Therefore, all of the PCs 20 may include the same functional blocks as those of the PC 20a.

Further, although there are plural image data such as the first projected projection image data, the projection image data which are being projected, and the combined image data, if the first projected projection image data are the same as the projection image data which are being projected, the projection image data which are being projected may be the same as the combined image data. The plural image data are identified by their names depending on their states of drawing. In the following explanation of information processing, these names are clarified.

The functional structure of the devices is described above. These functions are realized by a program executed by the CPU of the device. For example, in a case of the projector 10, a program for the projector is previously installed on the computer. In a case of the PC 20, an image projection program for PC terminal is installed on the computer.

### [Information Processing]

Hereinafter, information processing and operation on the projection system 100 of the embodiment are described.

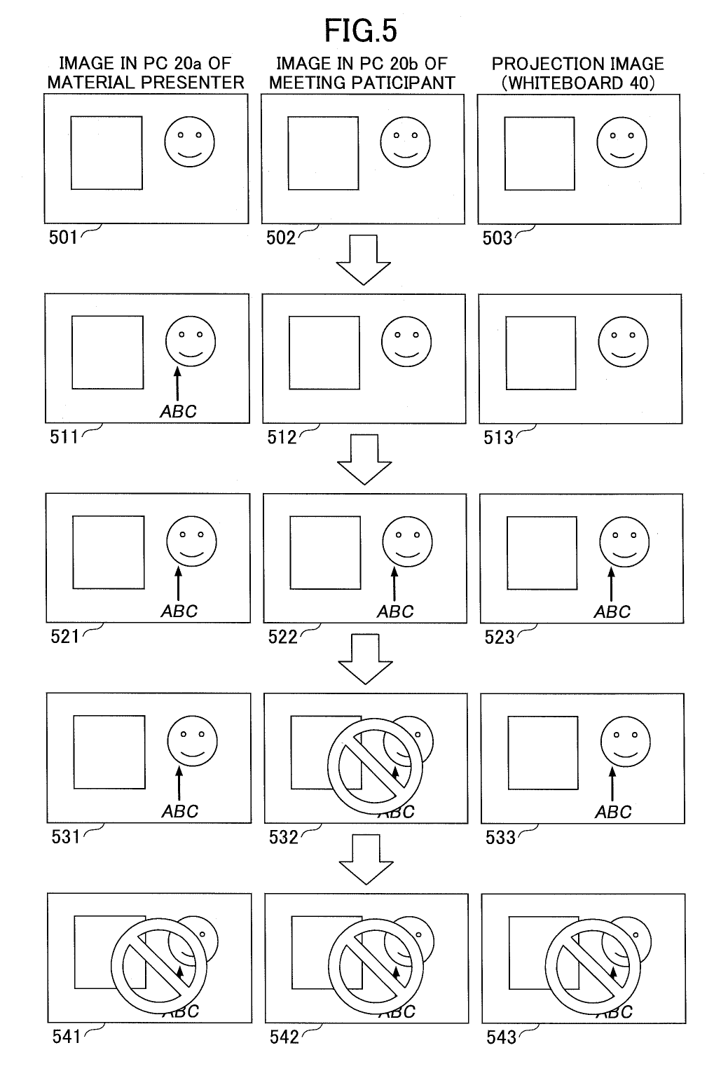

FIG. 5 is state transition diagrams illustrating the display of the PC 20 and the projection images. Referring to FIG. 5, the left column shows screens of the PC 20a used by a material presenter, the center column shows screens of the PCs 20b to 20e used by other meeting participants, and the right column shows projection images projected on the whiteboard 40. Hereinafter, referring to this state transition diagram, information processing of the embodiment is described.

### (Supplying Image Data, First Projection, and Reflection on the PC 20)

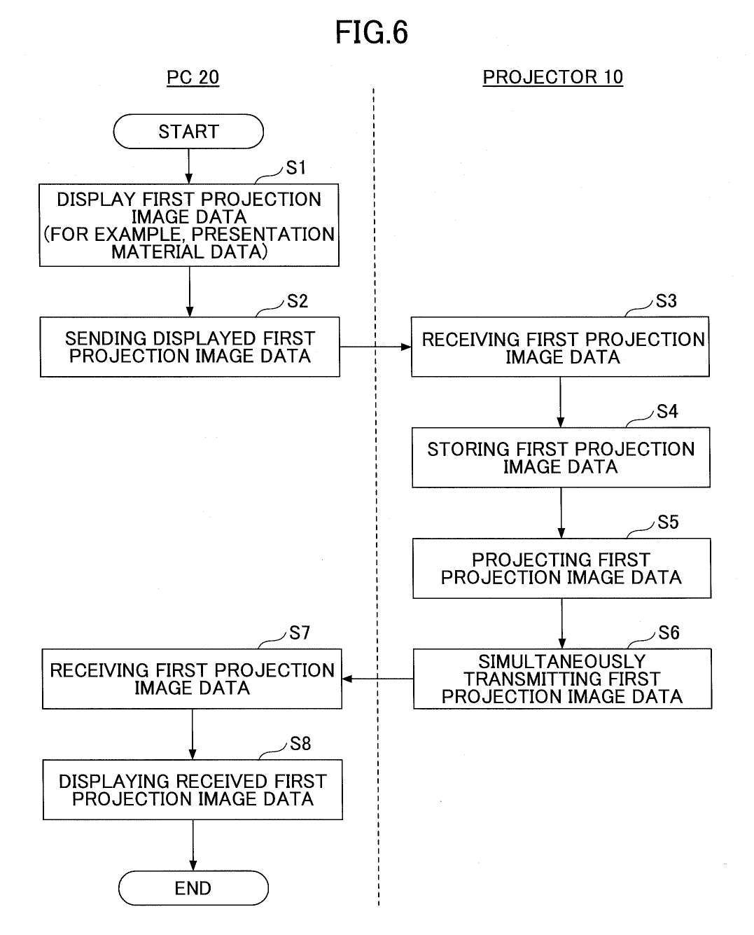

FIG. 6 is a flowchart illustrating a process of supplying image data from the PC 20a, first projection of the image data by the projector 10, and reflection on the personal computer.

In step S1, the displaying part 203 of the PC 20a used by the material presenter causes the projection image data to be first projected on the screen of the PC 20a by the projector 10. Specifically, the material presenter opens the presentation material data file from the local HDD so that the presentation material data are displayed on the screen of the PC 20a as illustrated in 501 of FIG. 5.

In step S2, the transmitting part of the PC 20a transmits the first projection image data to the projector 20. At this time, the first projection image data may be transmitted at a timing when the material presenter opens the presentation material data file from the local HDD, so that the presentation material data are displayed on the screen of the PC 20a.

In step S3, the receiving part 101 of the projector 20 receives the first projection image data transmitted from the PC 20a.

In step S4, the memory part 102 of the projector 20 temporarily stores the received first projection image data in the storage 123 or the like.

In step S5, the projecting part 104 of the projector 20 projects the first projection image data on the whiteboard 40 as illustrated in 503 of FIG. 5. At this time, because the drawing data is not received yet, the image combination is not performed yet by the image combining part 103. However, the image combining part 103 illustrated in FIG. 4 may combine the first projection data with blank drawing data containing nothing to thereby generate the combined image data which is the same as the first projection image data.

In step S6, the transmitting part 105 of the projector 20 simultaneously transmits the same projection data as the first projection data, which are being projected by the projector 10, to all of the PCs 20a to 20e.

In step S7, the receiving parts 201 of all of the PCs 20a to 20e participating in the meeting receive the first projection image data from the projector 20.

In step S8, the displaying parts 203 of all of the PCs 20a to 20e participating in the meeting display the received projection image data as illustrated in 501 and 502 of FIG. 5. Since the PC 20a supplies the first projection image data, there is consequently no change in the screen of the PC 20a. On the other hand, the projection image the same as the projection image being projected on the whiteboard 40 is reflected on the screens of the PCs 20b to 20e. Then, all of the meeting participants start the meeting while watching the projection images on the whiteboard 40 or the screens of the PCs 20a to 20e. Especially, the meeting participant at a distant place may watch the screen of the PC used by this meeting participant.

(Writing on the Image Data, Projection of these Image Data, and Reflection on the PC 20)

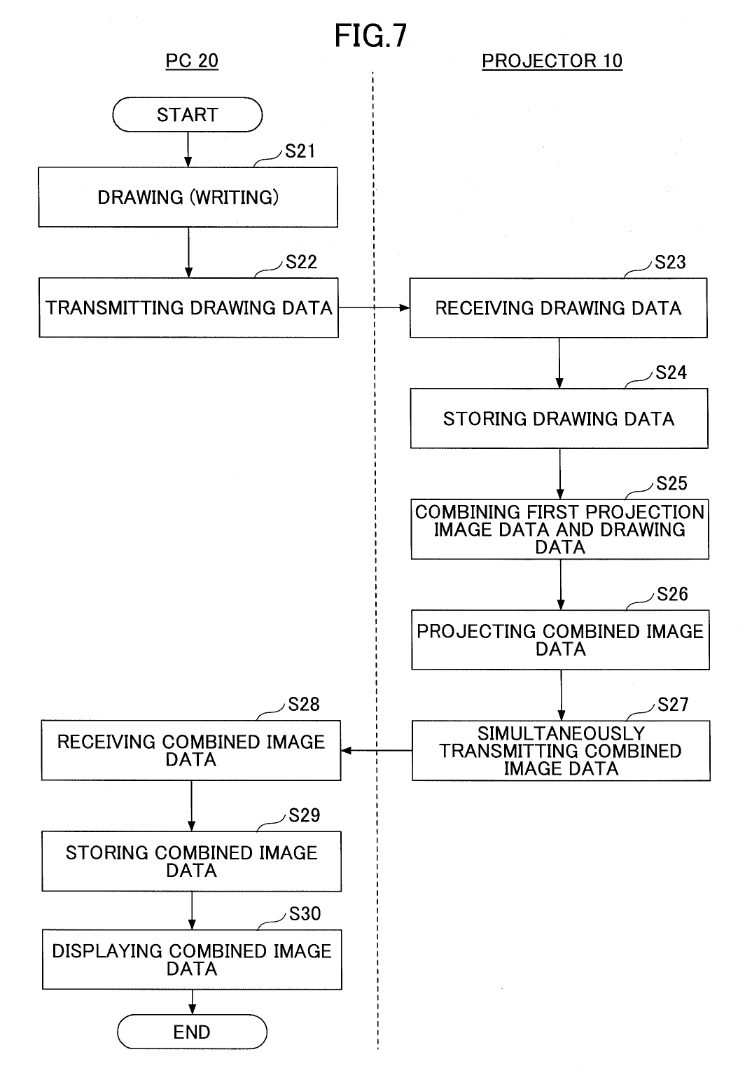

FIG. 7 is a flowchart illustrating writing on the image data displayed on the screen of the PC 20a, projection of the written data by the projector 10, and reflection of the written data on the personal computer 20.

In step S21, the drawing part 204 of the PC 20a additionally draws drawing data on the projection image data (501 of FIG. 5), which are being projected on the whiteboard 40 and displayed on the displaying part 203. Specifically, the material presenter writes drawing (makes some type of written content) on the projection image data displayed on the screen of the PC 20a using the input device 26 by operating a mouse, a keyboard or the like, as illustrated in 511 of FIG. 5. The written content is, for example, a character, a line, a figure or the like.

In step S22, the transmitting part 205 of the PC 20a transmits the drawing data corresponding to the written content to the projector 20. For example, the material presenter may transmit the drawing data at a timing of additionally write the drawing on the screen of the PC 20a. Further, the drawing data is transmitted in a unit of one character if the written content is text, in a unit of one line if the written content is lines, or in a unit of one FIG. 1f the written content is figures. Further, it is possible to transmit at a predetermined time interval irrespective of types of the written content, or it is possible to transmit the written content at the timing when the user transmits the drawing data to the projector 10. As the unit of transmitting the drawing data becomes smaller, the writing on the projection image is reflected further in real time. In order to specify the PC with which the drawing is written and also specify a position of writing the drawing on the projection image data on the screen of the PC at the time of transmitting the projection image data to the projector 10 or the like, attribute data of the drawing data are added to the projection image data. The attribute data are drawing position data such as an ordinate (x, y), a unique identifier for identifying the drawing data, and information of day and time, or the like. Exemplary attribute data are “PC20a-20110701-10:00-00001-(x1,y1)”.

In step S23, the receiving part 101 of the projector 20 receives the drawing data and the attribute data transmitted from the PC 20a.

In step S24, the memory part 102 of the projector 20 temporarily stores the drawing data on the storage 123 or the like. When the memory part 102 temporarily stores the drawing data, the drawing data are treated as an object. The memory part 102 further stores the attribute data including drawing position information, an identifier for identifying the drawing data, a transmission source (a PC in which the drawing is written), and a time in association with and in addition to the drawing data. The exemplary attribute data indicates that the drawing position information is (x1,y1); the identifier is 00001; the transmission source is PC20a; and the time is 20110701-10:00.

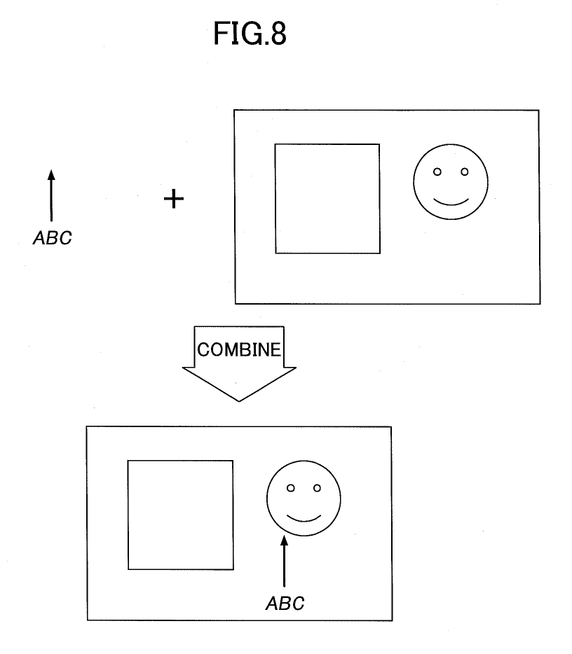

In step S25, the image combining part 103 of the projector 20 acquires the projection image data first projected from the memory part 102 and the drawing data, and combines the first projected projection image data with the drawing data with reference to the drawing position information. Said differently, the combined image data are generated. FIG. 8 illustrates an example of an image combination.

In step S26, the projecting part 104 of the projector 20 projects the combined image data on the whiteboard 40 as illustrated in 523 of FIG. 5.

In step S27, the transmitting part 105 of the projector 20 simultaneously transmits the same combined image data as the projection data, which are being projected by the projector 20, to all of the PCs 20a to 20e.

In step S28, the receiving parts 201 of all of the PCs 20a to 20e participating in the meeting receive the combined image data, which are being projected by the projector 20, from the projector 20.

In step S28, the memory parts 202 of all of the PCs 20a to 20e participating in the meeting stores the combined image data, which are being projected by the projector 20.

In step S30, the displaying parts 203 of all of the PCs 20a to 20e participating in the meeting display the received combined image data as illustrated in 521 and 522 of FIG. 5. Since the drawing is written in the PC 20a, the display of the PC 20a is not unchanged in step S30. Meanwhile, the projection image, on which the drawing is additionally written in the PC 20a, is reflected on the screens of the other PCs 20b to 20e.

(Writing on the Image Data, Projection of these Image Data, and Reflection on the PC 20)

Next, the PC 20b writes drawing on the image data after the PC 20b writes the drawing on the image data. Further, the explanation is given with reference to FIG. 7.

In step S21, the drawing part 204 of the PC 20a additionally draws drawing data on the projection image data (522 of FIG. 5), which are being projected on the whiteboard 40 and displayed on the displaying part 203. Specifically, the drawing part 204 additionally writes the drawing on the projection image data on the screen of the PC 20b as illustrated in 532 of FIG. 5.

In step S22, the transmitting part 205 of the PC 20b transmits drawing data corresponding to a written content and attribute data of the drawing data to the projector 20. In this, exemplary attribute data are, for example, “PC20b-2011070′-10:03-00002-(x2,y2)”.

In step S23, the receiving part 101 of the projector 20 receives the drawing data and the attribute data transmitted from the PC 20b.

In step S24, the memory part 102 of the projector 20 temporarily stores the drawing data on the storage 123 or the like. When the memory part 102 stores the drawing data, the attributed data added to the drawing data are also stored. The exemplary attribute data indicates that the drawing position information is (x2,y2); the identifier is 00002; the transmission source is PC20b; and the time is 20110701-10:03.

In step S25. the image combining part 103 of the projector 20 acquires the projection image data first projected from the memory part 102 and the drawing data, and combines the first projected projection image data with the drawing data with reference to the drawing position information. Said differently, the combined image data are generated. The newest combined image data are generated by combining the first projected projection image data, the drawing data from the PC 20a, and the drawing data from the PC 20b. Meanwhile, by storing the previous combined image data generated by combining the first projected projection image data with the former drawing data from the PC 20a in the memory part 102 of the projector 10, the newest combined data can be generated by further combining the latter drawing data from the PC 20b with the previous combined image data stored in the memory part 102.

In step S26, the projecting part 104 of the projector 20 projects the combined image data on the whiteboard 40 as illustrated in 543 of FIG. 5.

In step S27, the transmitting part 105 of the projector 20 simultaneously transmits the same combined image data as the projection data, which are being projected by the projector 20, to all of the PCs 20a to 20e.

In step S28, the receiving parts 201 of all of the PCs 20a to 20e participating in the meeting receive the combined image data, which are being projected by the projector 20, from the projector 20.

In step S29, the memory parts 202 of all of the PCs 20a to 20e participating in the meeting stores the combined image data, which are being projected by the projector 20. The received combined image data are overwritten on the previously stored combined image data. This is to store the newest combined image data in the memory parts 202. All of the combined image data may be stored by sequentially changing file names of the combined image data without overwriting the combined image data. However, all of the combined image data can be stored when a memory area has a space for storing these combined image data.

In step S30, the displaying parts 203 of all of the PCs 20a to 20e participating in the meeting display the received combined image data as illustrated in 541 and 542 of FIG. 5. Since the drawing is written in the PC 20b, the display of the PC 20b is not unchanged in step S30. Meanwhile, the projection image, which is additionally written in the PC 20b and is being projected on the whiteboard 40, is reflected on the screens of the other PCs 20a and 20c to 20e.

(Deleting Writing on the Image Data, Projection of the Image Data from which the Writing is Deleted, and Reflection on the PC 20)

Next, for example, the drawing is written in the image data in the PC 20b and thereafter the written drawing is deleted.

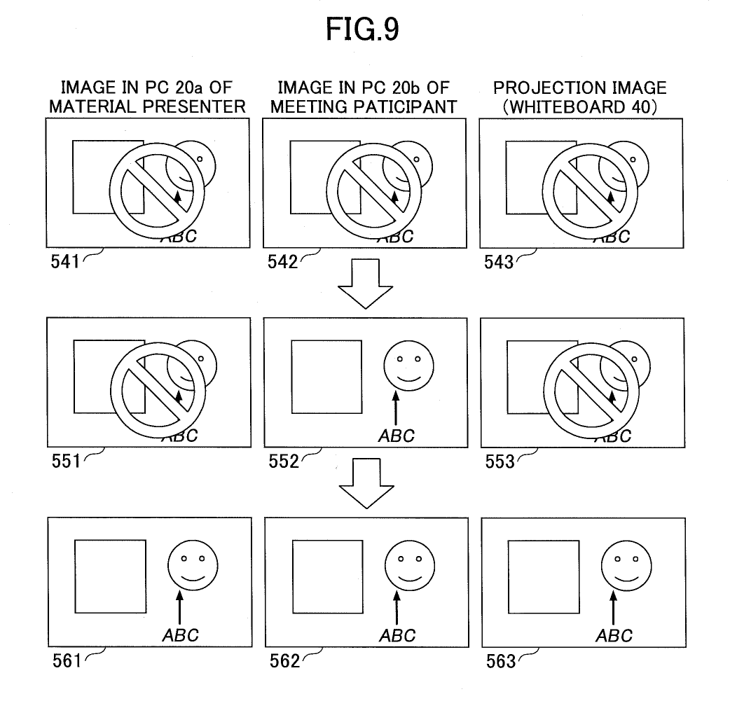

FIG. 9 is state transition diagrams illustrating displays of the PC 20a and the PCs 20b to 20e and the projection image. The state transition diagrams illustrated in FIG. 9 follows the state transition diagram illustrated in FIG. 5.

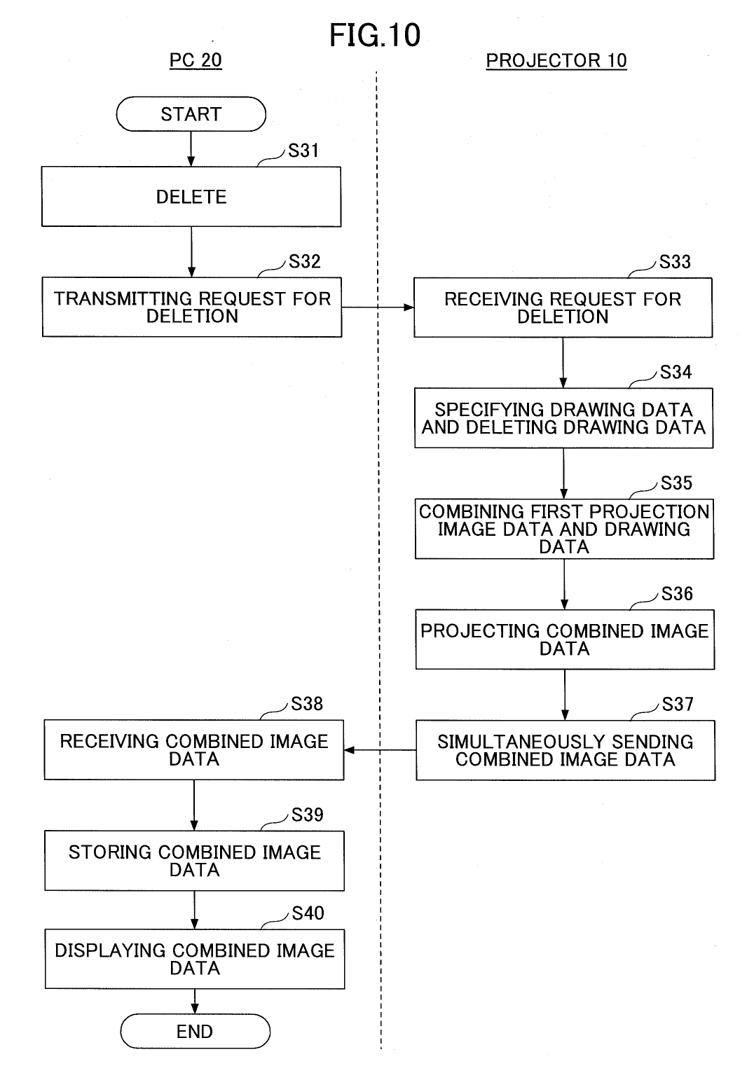

FIG. 10 is a flowchart illustrating the deletion of the drawing from the image data in the PC 20b, projection of image data, from which the drawing is deleted by the projector 10, and reflection of the image data on the PCs 20a, and 20b to 20e. The explanation is given along the flowchart.

In step S31, the drawing part 204 of the PC 20b deletes the drawing data (a drawing object) written in the projection image data which is being displayed on the displaying part 203 as illustrated in 552 of FIG. 9. Specifically, the user of the PC 20b operates a mouse, a keyboard or the like to select and delete the drawing data (the drawing object) from the input device 26.

In step S32, the transmitting part 205 generates a request for deletion indicative of deletion of the drawing data and sends the request for deletion and attribute data of the request for deletion to the projector 20. An exemplary attribute data of the drawing data to be deleted is “PC20b-20110701-10:03-00002-(x2,y2)”.

In step S33, the receiving part 101 of the projector 20 receives the request for deleting the drawing data and the attribute data transmitted from the PC 20b.

In step S34, the memory unit 102 of the projector 10 specifies the drawing data to which the deletion is requested based on the attribute data. Then, the specified drawing data are removed from the storage 123. Said differently, the drawing data specified by the attribute data “PC20b-20110701-10:03-00002-(x2,y2)” are removed.

In step S35. the image combining part 103 of the projector 20 acquires the projection image data first projected from the memory part 102 and the drawing data, and combines the first projected projection image data with the drawing data with reference to the drawing position information. Said differently, the combined image data are generated. Since the drawing data subjected to the request for deletion are already deleted by the memory part 102, the combined image data after the deletion are obtained by combining the first projected projection image data with the former drawing data from the PC 20a.

In step S36, the projecting part 104 of the projector 20 projects the combined image data on the whiteboard 40 as illustrated in 553 of FIG. 9.

In step S37, the transmitting part 105 of the projector 20 simultaneously transmits the same combined image data as the projection data, which are being projected by the projector 20, to all of the PCs 20a to 20e.

In step S38, the receiving parts 201 of all of the PCs 20a to 20e participating in the meeting receive the combined image data, which are being projected by the projector 20, from the projector 20.

In step S39, the memory parts 202 of all of the PCs 20a to 20e participating in the meeting stores the combined image data, which are being projected by the projector 20.

In step S40, the displaying parts 203 of all of the PCs 20a to 20e participating in the meeting display the received combined image data as illustrated in 561 and 562 of FIG. 9. Since the drawing is deleted in the PC 20b, the display of the PC 20b is not unchanged in step S40. Meanwhile, the drawing data, which are deleted in the PC 20b, disappear from the screen of the PCs 20a and 20c to 20e other than the PC 20b. Therefore, the projection image, which is being projected on the whiteboard 40, is reflected on and displayed on the screens of the PCs 20a and 20c to 20e.

As described, in the projection system 100 of the embodiment, the projector 10 projects the projection image and may transmit the projection image data to the PCs 20a, and 20c to 20e. The PCs 20a to 20e display the received projection image data. If the drawing is written on the projection image data by a user, the projector 10 combines the drawing data with the received projection image data, projects the combined image data, and transmits the combined image data which is being projected by the projector to the PCs 20a to 20e (a deletion is similarly processed). The PCs 20a to 20e stores the received combined image data in their local HDDs and display the received combined image data. With this, all of the meeting participants including who exist near and far from the whiteboard 40 can write drawing on a projection image (e.g., a presentation material) on the whiteboard 40. Further, projection image data, in which drawing is written and which are being projected, are shared and stored by the PCs 20a to 20e without changing image quality of the projection image data as electronic data.

### Modified Example

The modified example of the embodiment is described.

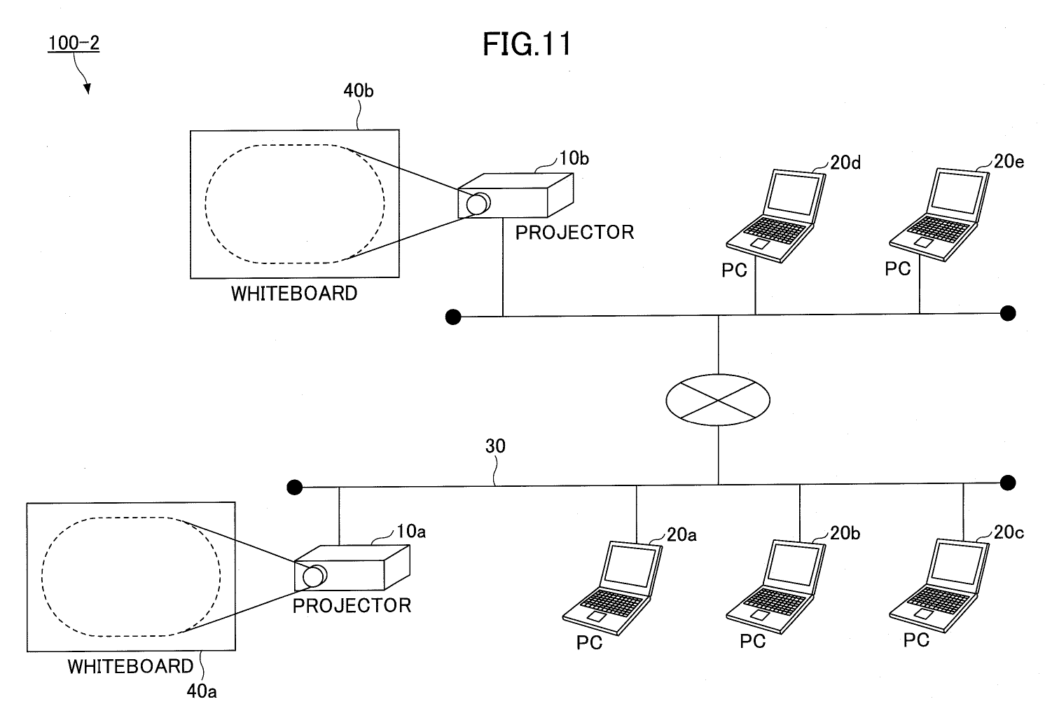

FIG. 11 illustrates a network structure of an projection system of the modified example of the embodiment. In comparison with FIG. 1, plural projectors are added in a projection system 100-2 of the embodiment. Specifically, another projector 10b is located at a distant place. In this case, the projector 10a and the other projector 10b are operated in a relationship between a parent unit and a subsidiary unit, respectively.

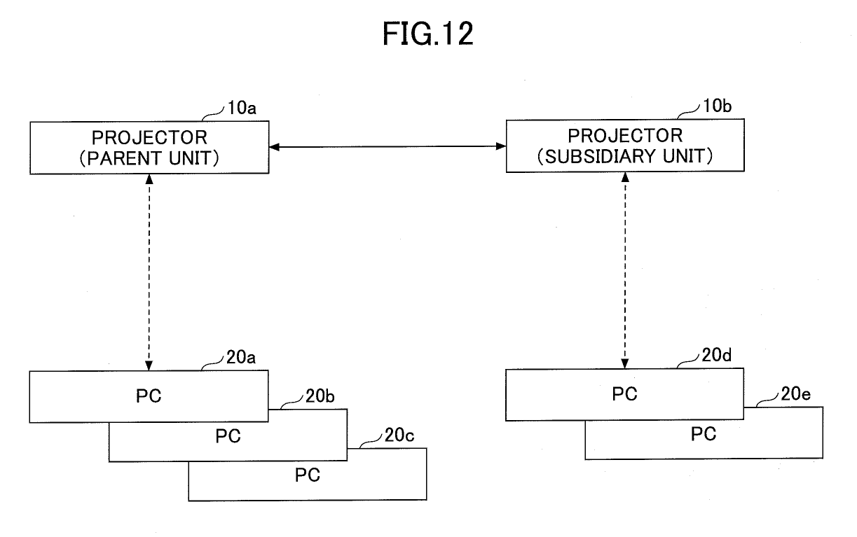

FIG. 12 illustrates a functional relationship of the projection system 100-2 of the modified example of the embodiment. The projector 10a functioning as the parent unit is operated as described above. The projector 10a transmits the projection image data (including the combined image data) to the projector 10b. In this case, the projector 10b is treated like the PC 20 of the embodiment described above. The projector 10 projects the received projection image data (including the combined image data) on a whiteboard 40b as a projection image.

As described, it is possible to project the projection image on the whiteboard 40b when the other projector is positioned at the distant place. Thus, other meeting participants D and E at the distant place can participate in the meeting while watching the whiteboard 40b in addition to screens of the PCs 20d and 20e. By operating the PCs 20d and 20e, it is possible to write a drawing on projection image data (including the combined image data). The drawing written in the projection image data is reflected on the projection image which is being projected on the whiteboard 40a and the whiteboard 40b (a deletion is similarly processed).

Further, the projector 10a functioning as the parent unit may not transmit the projection image data directly to the PCs 20d and 20e when the projection image data (including the combined image data) are transmitted to the PCs 20d and 20c at the distant place. The projector 10a may transmit the projection image data to the projector 10b functioning as the subsidiary unit, and the projector 10b may transmit the projection image data to the PCs 20d and 20e in order for load sharing.

### [General Overview]

Within the embodiment, it is possible to provide a projection system, a projector, and a projection method, with which all of meeting participants can write drawing (additional information) such as a character and a figure on a projected image projected by a projector and storage capability of storing images having the drawing written in these can be improved.

All examples and conditional language recited herein are intended for pedagogical purposes to aid the reader in understanding the principles of the invention and the concepts contributed by the inventor to furthering the art, and are to be construed as being without limitation to such specifically recited examples and conditions, nor does the organization of such examples in the specification relate to a showing of the superiority or inferiority of the invention. Although has been described in detail, it should be understood that various changes, substitutions, and alterations could be made thereto without departing from the spirit and scope of the invention.

This patent application is based on Japanese Priority Patent Application No. 2011-168664 filed on Aug. 1, 2011, the entire contents of which are hereby incorporated herein by reference.

What is claimed is:

1. An projection system comprising:
a computer; and
a projector configured to project projection image data received from the computer,
wherein the computer includes
a receiving part configured to receive the projection image data, which are projected, from the projector,
a drawing part configured to draw drawing data, which are additionally drawn on the projection image data, and
a transmitting part configured to transmit the drawing data to the projector,
wherein the projector includes
a transmitting part configured to transmit the projection image data to the computer,
a receiving part configured to receive the drawing data from the computer,
an image combining part configured to generate combined image data by combining the projection image data, which are projected, with the drawing data, and
a projecting part configured to project the combined image data as projection image data.

2. The projection system according to claim 1,
wherein the computer further includes
a memory part configured to store the received projection image data, which are projected.

3. The projection system according to claim 1,
wherein the computer further includes
a displaying part configured to display the received projection image data, which are projected.

4. The projection system according to claim 1,
wherein the transmitting part of the computer transmits attribute data of the drawing data along with the drawing data, and
wherein the projector further includes
a memory part configured to store the received drawing data and the attribute data of the received drawing data by associating the received drawing data and the attribute data.

5. The projection system according to claim 4,
wherein the transmitting part of the computer transmits the attribute data of the drawing data along with a request for deleting the drawing data,
wherein the memory part of the projector deletes the drawing data associated with the attribute data of the drawing data which is received together with the request for deleting drawing data from the memory part of the projector,
wherein the image combining part of the projector generates the combined image data in which the drawing data is deleted from the projection image data, which are projected.

6. The projection system according to claim 1, further comprising:
another projector connected to the computer and the projector via a network,
wherein the transmitting part of the projector transmits the projection image data, which are projected, to the other projector,
wherein the other projector includes a projecting part configured to project the received projection image data, which are projected.

7. A projector comprising:
a transmitting part configured to transmit projection image data, which are projected, to a computer,
a receiving part configured to receive drawing data, which are additionally drawn on the projection image data, which are projected, from the computer,
an image combining part configured to generate combined image data by combining the projection image data, which are projected, with the drawing data, and
a projecting part configured to project the combined image data as projection image data,
wherein the transmitting part transmits the combined image data as the projection image data, which are projected.

8. An projection method comprising:
receiving, by a computer, projection image data, which are projected, from a projector configured to project projection image data received from the computer;
drawing, by the computer, drawing data, which are additionally drawn on the projection image data;
transmitting, by the computer, the drawing data to the projector;
transmitting, by the projector, the projection image data to the computer;
receiving, by the projector, the drawing data from the computer;
generating, by the projector, combined image data by combining the projection image data, which are projected, with the drawing data; and
projecting, by the projector, the combined image data as projection image data.

9. The projection method according to claim 8, further comprising:
storing, by the computer, the received projection image data, which are projected.

10. The projection method according to claim 8, further comprising:
displaying, by the computer, the received projection image data, which are projected.

11. The projection method according to claim 8,
wherein the transmitting, by the computer, transmits the attribute data of the drawing data along with the drawing data,
wherein the projection method further comprises:
storing, by the projector, the received drawing data and the attribute data of the received drawing data by associating the received drawing data and the attribute data.

12. The projection method according to claim 11,
wherein the transmitting, by the computer, transmits attribute data of the drawing data along with a request for deleting the drawing data,
wherein the storing, by the projector, deletes the drawing data associated with the attribute data of the drawing data which are received together with the request for deleting drawing data from the projector,
wherein the generating, by the projector, generates the combined image data in which the drawing data is deleted from the projection image data, which are projected.

13. The projection method according to claim 8, further comprising:
wherein the transmitting part of the projector transmitting the projection image data, which are projected, to another projector connected to the computer and the projector via a network; and
projecting, by the other projector, the received projection image data, which are projected.
